(19) United States
(12) Patent Application Publication
(10) Pub. No.: US 2021/0271369 A1
(43) Pub. Date: Sep. 2, 2021

(54) TOOL TRACKING AND TASK MANAGEMENT IN A THREE-DIMENSIONAL ENVIRONMENT

(71) Applicant: The Boeing Company, Chicago, IL (US)

(72) Inventors: Kurt Webster, Los Gatos, CA (US); Donald W. Coffland, Seattle, WA (US); Natalia Roberts, Kent, WA (US)

(21) Appl. No.: 16/802,726

(22) Filed: Feb. 27, 2020

(51) Int. Cl. G06F 3/0481; G05B 19/402

(52) U.S. Cl. CPC G06F 3/04815; G05B 19/402; G05B 2219/50047; G05B 2219/32128; G05B 2219/35415

(57) ABSTRACT

A system for affixing a fastener or fastener collar is provided including a handheld tool configured to engage a corresponding fastener; a communication device affixed to the handheld tool and configured to communicate with a base station; and a computer. In some example implementations, the computer is configured to receive an identification of a position of the handheld tool within a region of three-dimensional space, and determine, based on the position of the handheld tool and a user input, a location of the corresponding fastener. A digital representation of the region of three-dimensional space with an identification of the location of the corresponding fastener can then be generated; along with a graphical user interface including a visual representation of the map of the three-dimensional space and a visual representation of the location of the corresponding fastener.

### TECHNOLOGICAL FIELD

The present disclosure relates generally to tool tracking and task management in complex manufacturing contexts and, in particular, to the generation and use of virtual reality-based approaches to track, document, and guide the use of tools in a three-dimensional environment.

### BACKGROUND

In many of today's advanced products, multiple complex product systems and component may reside together in the same general area of space. For example, in the context of the engine well of a car, for example, multiple components (such as engine components, portions of the electrical system, various fluid storage and distribution system, air handling systems, and the like) may all reside in close proximity to each other. Depending on the design of the product and the methods used to manufacture or repair the product, some components may be at least partially installed or partially uninstalled multiple times before the completion of final assembly or repairs to allow for the manufacture, installation, or repair of other components. Consequently, and especially in complex systems where it can be difficult to visually verify the location and status of one or more components, technical challenges can arise with respect to tracking and documenting the work done with respect to a given set of components. Additional technical challenges can arise with respect to training of personnel to perform certain production or repair tasks, and the verification that necessary operations were completed according to the relevant specifications or plans. These and other technical challenges can be further compounded in situations where the complexity, component density, and other design aspects of a given product produce situations where product drawings, schematic diagrams, and other design documentation are difficult to decipher and combine to identify the location of the particular components associated with a given task within the relevant space.

Therefore, it would be desirable to have a system and method that takes into account at least some of the issues discussed above, as well as other possible issues.

### BRIEF SUMMARY

Example implementations of the present disclosure are directed to tool tracking and task management in complex manufacturing contexts and, in particular, to the generation and use of virtual reality-based approaches to track, document, and guide the use of tools in a three-dimensional environment. In order to address a number of technical challenges, including but not limited to those discussed here, example implementations of the present disclosure involve the use of tools that are equipped with communication devices (such as those used to identify the positions of virtual-reality controllers, for example) to accurately and precisely determine and capture the position of the tool within a relevant three-dimensional space where the tool may be used. In some example situations, such as those that arise in contexts where the precise location of one or more fasteners, fastener collars, or other components has not been previously mapped or stored, the position of the tool (which is equipped with its communication device) can be used to identify and document the location of the relevant component when the tool is engaged with the component. As such, a digital representation of the three dimensional space (which may be referred to herein as a “map”) can be generated and the position of the relevant fastener, fastener collar, or other component can be stored, associated with the digital representation of the relevant space, and shown to a user via a graphic user interface (GUI) or other interface.

In some example implementations, additional information regarding the use of the tool may be captured and stored along with the position of the relevant fastener, fastener collar, or other component, depending on the information available from the tool or determinable from the movement of the tool. For example, in contexts where the tool is a torque wrench with an affixed communication device, the torque applied to a nut and/or the direction of force applied by the tool may be captured, stored, compared against a specification, added to the digital representation of the space, shown to a user, or otherwise used.

In some example implementations, such as situations where the positions of fasteners, fastener collars, other components, or other points in a relevant space are known and have been added to a digital representation or other map of the space, for example, the position of the tool (equipped with a communication device) can be used to guide or otherwise manage one or more tasks associated with the tool. For example, by determining the relative position of the tool with respect to a fastener, other component or point, an indication can be provided to the user of the tool to guide the tool to the relevant location. In some example implementations, that indication may take the form of a visual representation on a GUI. In some example implementations, such as situations where the relevant point may be visually blocked by one or more other components or otherwise hard to see the feedback may be in the form of visual, audio, or haptic feedback provided to the user at the tool. For example, the tool and/or its communication device may be configured to provide a series of beeps or other tones that change in pitch or tempo as the tool is placed closer to or farther away from the relevant fastener or other point.

It will be appreciated that many of the examples described or otherwise disclosed herein arise in the context of the production, maintenance, or repair of aircraft, and thus may use terms that are indicative of such context. However, the use of such contexts and terms in connection with one or more examples should not be interpreted as limiting other example implementation, or aspects of the present disclosure, to an aircraft-specific context.

The present disclosure thus includes, without limitation, the following example implementations.

Some example implementations provide a system for affixing a fastener or fastener collar, the system comprising: a handheld tool configured to engage a corresponding fastener or fastener collar; a communication device affixed to the handheld tool and configured to wirelessly communicate with a base station; and a computer configured to: receive, from the base station, data identifying a position of the handheld tool within a region of three-dimensional space; determine, based on the position of the handheld tool and a user input, a location of the corresponding fastener or fastener collar; generate a digital representation of the region of three-dimensional space including an identification of the location of the corresponding fastener or fastener collar; and generate a graphical user interface (GUI) including a visual representation of the map of the three-dimensional space and a visual representation of the location of the corresponding fastener or fastener collar.

In some example implementations of the system of any preceding example implementation, or any combination of any preceding example implementations, the handheld tool is a torque wrench, and the communication device is configured to transmit a torque status of the corresponding fastener or fastener collar to the base station; and the computer is further configured to: receive the torque status of the corresponding fastener or fastener collar; store a record of the torque status of the corresponding fastener or fastener collar; and provide an indication the torque status via the GUI.

In some example implementations of the system of any preceding example implementation, or any combination of any preceding example implementations, the communication device is further configured to receive the user input via a user interface of the communication device and transmit a signal to the base station to cause the computing device to record the position of the handheld tool within the region of three-dimensional space on the map.

In some example implementations of the system of any preceding example implementation, or any combination of any preceding example implementations, the visual representation of the region of three-dimensional space comprises a rendering of the region of three-dimensional space and a rendering of the corresponding fastener or fastener collar applied to the rendering of the region of three-dimensional space in a position on the GUI corresponding to the location of the corresponding fastener or fastener collar within the region of three-dimensional space.

Some example implementations provide a system for affixing a fastener or fastener collar, the system comprising: a handheld tool configured to engage a corresponding fastener or fastener collar; a communication device affixed to the handheld tool and configured to wirelessly communicate with a base station; and a computer configured to: receive, from the base station, data identifying a position of the handheld tool within a region of three-dimensional space; access a map of the region of three dimensional space, including an identification of the location of the corresponding fastener or fastener collar; and determine, based on the position of the handheld tool and the identification of the location of the corresponding fastener or fastener collar, a relative position of the handheld tool with respect to the corresponding fastener or fastener collar; and provide an indication of the relative position of the handheld tool with respect to the corresponding fastener or fastener collar.

In some example implementations of the system of any preceding example implementation, or any combination of any preceding example implementations, the computer being configured to determine the relative position of the handheld tool with respect to the corresponding fastener or fastener collar comprises the computer being configured to: apply the position of the handheld tool within the region of three-dimensional space to the map; and determine a difference between the applied position of the handheld tool and the identification of the location of the corresponding fastener or fastener collar

In some example implementations of the system of any preceding example implementation, or any combination of any preceding example implementations, the computer being configured to provide an indication of the relative position of the handheld tool with respect to the corresponding fastener or fastener collar, comprises the computer being configured to: generate a graphical user interface (GUI) including a visual representation of the map of the three-dimensional space, a visual representation of the location of the corresponding fastener or fastener collar, and a visual indication of the position of the handheld tool with respect to the corresponding fastener or fastener collar.

In some example implementations of the system of any preceding example implementation, or any combination of any preceding example implementations, the computer being configured to provide an indication of the relative position of the handheld tool with respect to the corresponding fastener or fastener collar, comprises the computer being configured to transmit to the communication device, via the base station, the indication of the relative position of the handheld tool with respect to the corresponding fastener or fastener collar; and the communication device is further configured to provide visual, audio, or haptic feedback to the user based on the indication of the relative position of the handheld tool with respect to the corresponding fastener or fastener collar.

In some example implementations of the system of any preceding example implementation, or any combination of any preceding example implementations, a characteristic of the visual, audio or haptic feedback is based at least in part of the relative position of the handheld tool with respect to the corresponding fastener of fastener collar.

In some example implementations of the system of any preceding example implementation, or any combination of any preceding example implementations, the map further includes an identification of a location of a second corresponding fastener or fastener collar.

In some example implementations of the system of any preceding example implementation, or any combination of any preceding example implementations, the computer is further configured to determine, based on the position of the handheld tool and the identification of the location of the second corresponding fastener or fastener collar, a relative position of the handheld tool with respect to the second corresponding fastener or fastener collar; and provide an indication of the relative position of the handheld tool with respect to the second corresponding fastener or fastener collar.

Some example implementations provide for a method for affixing a fastener or fastener collar, the method comprising: receiving, at a computer, from a base station, data identifying a position, within a region of three-dimensional space, of a handheld tool to which a communication device is affixed; determining, based on the position of the handheld tool and a user input, a location of a corresponding fastener or fastener collar; generating a digital representation of the region of three-dimensional space including an identification of the location of the corresponding fastener or fastener collar; and generating a graphical user interface (GUI) including a visual representation of the map of the three-dimensional space and a visual representation of the location of the corresponding fastener or fastener collar.

In some example implementations of the method of any preceding example implementation, or any combination of any preceding example implementations, the handheld tool is a torque wrench and the communication device configured to transmit a torque status of the corresponding fastener or fastener collar to the base station; the method further comprising: receiving the torque status of the corresponding fastener or fastener collar; storing a record of the torque status of the corresponding fastener or fastener collar; and providing an indication the torque status via the GUI.

In some example implementations of the method of any preceding example implementation, or any combination of any preceding example implementations, the communication device is further configured to receive the user input via a user interface of the communication device and transmit a signal to the base station to cause the computing device to record the position of the handheld tool within the region of three-dimensional space on the map.

In some example implementations of the method of any preceding example implementation, or any combination of any preceding example implementations, the visual representation of the region of three-dimensional space comprises a rendering of the region of three-dimensional space and a rendering of the corresponding fastener or fastener collar applied to the rendering of the region of three-dimensional space in a position on the GUI corresponding to the location of the corresponding fastener or fastener collar within the region of three-dimensional space.

Some example implementations provide for a method for affixing a fastener or fastener collar, the method comprising: receiving, at a computer, from a base station, data identifying a position, within a region of three-dimensional space, of a handheld tool to which a communication device is affixed; accessing a map of the region of three dimensional space, including an identification of the location of the corresponding fastener or fastener collar; and determining, based on the position of the handheld tool and the identification of the location of the corresponding fastener or fastener collar, a relative position of the handheld tool with respect to the corresponding fastener or fastener collar; and provide an indication of the relative position of the handheld tool with respect to the corresponding fastener or fastener collar.

In some example implementations of the method of any preceding example implementation, or any combination of any preceding example implementations, the method further comprises: applying the position of the handheld tool within the region of three-dimensional space to the map; and determining a difference between the applied position of the handheld tool and the identification of the location of the corresponding fastener or fastener collar.

In some example implementations of the method of any preceding example implementation, or any combination of any preceding example implementations, providing an indication of the relative position of the handheld tool with respect to the corresponding fastener or fastener collar further comprises generating a graphical user interface (GUI) including a visual representation of the map of the three-dimensional space, a visual representation of the location of the corresponding fastener or fastener collar, and a visual indication of the position of the handheld tool with respect to the corresponding fastener or fastener collar.

In some example implementations of the method of any preceding example implementation, or any combination of any preceding example implementations, providing an indication of the relative position of the handheld tool with respect to the corresponding fastener or fastener collar, comprises the computer being configured to transmit to the communication device, via the base station, the indication of the relative position of the handheld tool with respect to the corresponding fastener or fastener collar; and the communication device is further configured to provide visual, audio, or haptic feedback to the user based on the indication of the relative position of the handheld tool with respect to the corresponding fastener or fastener collar.

In some example implementations of the method of any preceding example implementation, or any combination of any preceding example implementations, a characteristic of the visual, audio or haptic feedback is based at least in part of the relative position of the handheld tool with respect to the corresponding fastener of fastener collar.

In some example implementations of the method of any preceding example implementation, or any combination of any preceding example implementations, the map further includes an identification of a location of a second corresponding fastener or fastener collar.

In some example implementations of the method of any preceding example implementation, or any combination of any preceding example implementations, the method further comprises determining, based on the position of the handheld tool and the identification of the location of the second corresponding fastener or fastener collar, a relative position of the handheld tool with respect to the second corresponding fastener or fastener collar; and providing an indication of the relative position of the handheld tool with respect to the second corresponding fastener or fastener collar.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a system for affixing a fastener or fastener collar according to example implementations of the present disclosure;

FIG. 2 illustrates a functional block diagram of the system presented in FIG. 1, according to example implementations of the present disclosure;

FIG. 3 is a flowchart illustrating various steps in an example method of affixing a fastener or fastener collar, according to example implementations;

FIG. 4 is a flowchart illustrating various steps in another example method of affixing a fastener or fastener collar, according to example implementations; and

FIG. 5 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Also, something may be described as being above something else (unless otherwise indicated) may instead be below, and vice versa; and similarly, something described as being to the left of something else may instead be to the right, and vice versa. Like reference numerals refer to like elements throughout.

Example implementations of the present disclosure are directed to tool tracking and task management in complex manufacturing contexts and, in particular, to the generation and use of virtual reality-based approaches to track, document, and guide the use of tools in a three-dimensional environment.

Many of today's complex products are designed such that subassemblies and other components associated with multiple difference functions or operations of the product are affixed, routed through, or otherwise located in a shared three-dimensional space. For example, the wheel well of an aircraft may hold various components and aspects of multiple different mechanical, hydraulic, fluid transport, and electrical subassemblies. In situations where product subassemblies and other components are placed in close proximity to each other, it can become difficult for a technician of other individual or entity to establish a clear view or line of sight to one or more components. Moreover, in some situations, the geometry and component density of a part of a product may make it difficult to locate all of the fasteners, fastener collars, or other components that may be the subject of a particular manufacturing, maintenance, or repair operation.

Regardless of the specific details of a given product or portion of a product, the effective and efficient manufacture, maintenance, and repair of complex products often depends on a person's ability to locate and operate on a particular component in a relevant space. Particularly in situations where multiple different people may be involved in working on various components in the space at different times, effectively capturing and documenting the location of the components, the operations performed on those components, and the status of the components at a particular time can help accelerate and improve the manufacture, maintenance, and repair of a product.

Some example implementations of the present disclosure overcome technical challenges and achieve technical advantages by incorporating or otherwise affixing a communication device to a handheld tool, using one or more base stations and computers to determine the position and movement of the tool within relevant three-dimensional space, and creating a virtual reality environment or other digital representation of the three-dimensional space and relevant features (such as the position of one or more fasteners for example). Depending on the structure of the tool, its movement within the space, information generated or acquired by the tool, and other actions performed in conjunction with the tool, the digital representation of the three-dimensional space, or records stored in association with the digital representation, can be used to document the location of relevant components, operations performed on those components, and a status of those components at a particular time. It will be appreciated that while some examples described herein use the terms “position” and “orientation” to clarify aspects of such examples, the position of any object of interest can be fully defined in six degrees of freedom. As used herein, the term “position” can refer to a position defined in terms of six degrees of freedom, and information pertaining to the position of any object of interest can include information about any number of degrees of freedom, including but not limited to six degrees of freedom. It will also be appreciated that the Vive system, which is an example of a system that can be used in conjunction with example implementations of the present disclosure, can be used to obtain and determine six-degree of freedom object position data.

Some example implementations of the present disclosure involve the use of a previously-developed map (such as a digital representation of the three-dimensional space, for example), that captures the location of one or more fasteners or other components within the space. In some such example implementations, the known position of the fasteners or other components can be used in connection with a determined position of a tool equipped with a communication device to guide or otherwise assist a user in locating the relevant fasteners or other components and completing a related task.

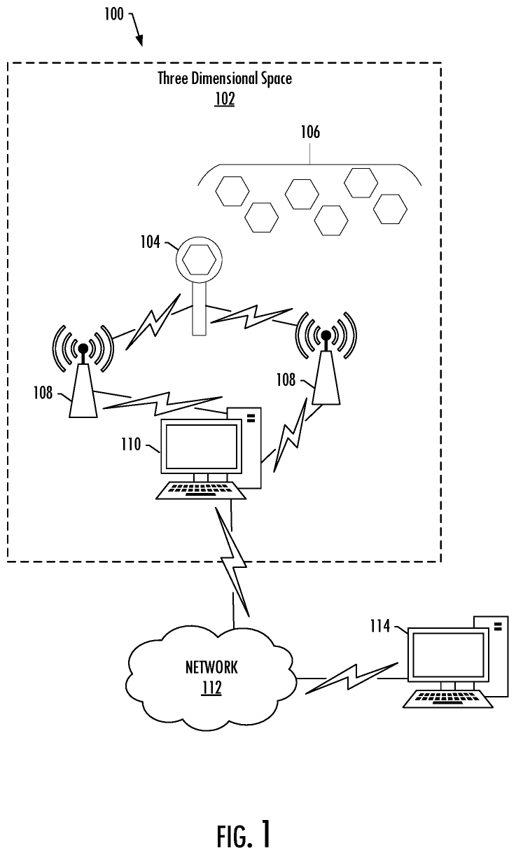

FIG. 1 illustrates a system 100 for affixing a fastener or fastener collar according to example implementations of the present disclosure. The system may include any of a number of different subsystems (each an individual system) for performing one or more functions or operations. As shown, in some examples, the system includes a tool 104, that is configured to engage or otherwise interact with one or more fasteners, fastener collars, or other components 106 and wirelessly communicate with the one or more base stations 108. As shown in FIG. 1, the tool 104, fasteners, fastener collars, or other components 106, and the base station(s) 108 are located within a three-dimensional space 102, which may also include a control system 110. While control system 110 is shown in FIG. 1 as being located within the three-dimensional space 102, it will be appreciated that the control system 110 may be located outside of the three-dimensional space 102 in some example implementations. In system 100, the base station(s) 108 are configured to communicate with the control system 110 via a wired or wireless connection. In some examples, the tool 104, control system 110, and one or more of base stations 108 may communicate with one another across one or more computer networks 112. In the example system 100 shown in FIG. 1, a remote system 114 is also configured to communicate with one or more of the other systems in FIG. 1 via one or more computer networks 112. Further, although shown as part of the system 100, it should be understood that any one or more of the above may function or operate as a separate system without regard to any of the other subsystems. It should also be understood that the system may include one or more additional or alternative subsystems than those shown in FIG. 1.

Some example implementations of system 100 arise in contexts where the locations of the fasteners, fastener collars, or other components 106 within the three-dimensional space 102 are not known, at least in the sense that the locations of the fasteners, fastener collars, or other components 106 are not stored in association with a map or other digital representation with or otherwise accessible by the control system 110. In such example implementations, tool 104 is a handheld tool configured to engage or otherwise interact with the fasteners, fastener collars, or other components 106. In the example shown in FIG. 1, tool 104 is configured as a torque wrench. In example implementations of system 100, a communication device is incorporated into or otherwise affixed to the tool 104 and configured to wirelessly communicate with the one or more base stations 108. In some example implementations, the communication device and base stations incorporate augmented reality system components, virtual reality system components, and/or mixed reality system components (such as HTC Vive virtual reality system components, for example) or other system components capable of determining the movement and position of the communication device (and thus the tool) on a sub-centimeter or sub-millimeter scale. The base stations 108 may then communicate with the control system 110 (either through direct wired or wireless communication, or via a network 112) to pass the position of the tool to the control system 110.

Upon receiving from the base station(s) 108 data identifying the position of the tool 104, the control system 110 uses the information and a user input (such as press of a button on the tool 104 or on an interface of the control system 110, for example) to determine location of a fastener, fastener collar, or other component 106. Some example implementations contemplate that, upon engagement of the tool 104 on a fastener, fastener collar, or other component 106 a person using the tool or another person will provide input to the control system 110 indicating that the tool is at a location associated with a fastener, fastener collar, or other component 106.

After determining the position of a fastener, fastener collar, or other component 106, or all such fasteners, fastener collars, or other components 106 in a given three-dimensional space 102, the control system 110 may generate a digital representation of the region of three dimensional space, including an identification of the location of the relevant fastener, fastener collar, or other component 106. As noted above, some example implementations of the present disclosure involve the use of one or more base stations in communication with a tool 104, and the region of three-dimensional space 102 may be defined by the effective communication range of the base station(s) 108 and the tool 104. In other example implementations, such as those that arise in situations where the dimensions of the space in which the relevant components are located are generally known (such as an aircraft wheel well or other portion of an aircraft, for example), those dimensions may be used to establish boundaries of the three dimensional space 102. In other example implementations, the digital representation of the three-dimensional space 102 may include less detail regarding the three-dimensional space 102 itself, and instead be based on the captured location information associated with the one or more fasteners, fastener collars, or other components 106 such that physical boundaries of a wheel well, other portion of an aircraft, or other bounded space are not reflected in the digital representation of the three-dimensional space.

Regardless of the precise form of the digital representation of the three-dimensional space 102, the control system may also generate a graphical user interface (GUI) that includes a visual representation of the digital representation or other map of the three-dimensional space 102 and a visual representation of the location of the corresponding fastener, fastener collar, or other component 106.

As such, some example implementations of the present disclosure include using a tool 104 that is equipped with a communication device capable of interacting with a base station 108 to determine the position of the tool to generate a digital representation or other map of the location of fastener, fastener collar, or other component 106.

Some example implementations of system 100 arise in situations where a map of the locations of relevant fasteners, fastener collars, or other components 106 has already been generated and stored in a manner accessible by the control system 110. In some such example situations, the ability of the system 100 to use the base station(s) 108 to ascertain the position of the tool 104 within the three-dimensional space can be leveraged to improve many of the tasks and other operations associated with the manufacture, maintenance, and repair of products in a given space. Upon receiving from the base station(s) 108 data identifying the position of the tool 104 within the three-dimensional space 102, the control system 110 may access a map of the relevant three-dimensional space, including an identification of the location of one or more fasteners, fastener collars, or other components 106. Based on the position of the tool 104 and the information associated with the map of the three-dimensional space 102, a relative position of the tool 104 with respect to a given fastener, fastener collar, or other component 106 can be determined and an indication of that relative position can be provided to a user. In some example implementations, that indication may be provided via a GUI of the control system, via visual, audio, or haptic feedback on the tool 104, or to a viewer in another location via remote system 114.

As such, some example implementations of the present disclosure contemplate the use of the position of a tool 104 and a predetermined map of a three-dimensional space 102 to provide a user with an indication of the position of the tool 104 with respect to a relevant fastener, fastener collar, or other component 106. The ability to recognize the movement of a tool 104 within a three-dimensional space and the relationship of that movement with respect to a fastener, fastener collar, or other component 106 can be used in a number of example implementations described or otherwise disclosed herein to overcome technical challenges and realize technical advantages with respect to the manufacture, maintenance, and repair of complex products.

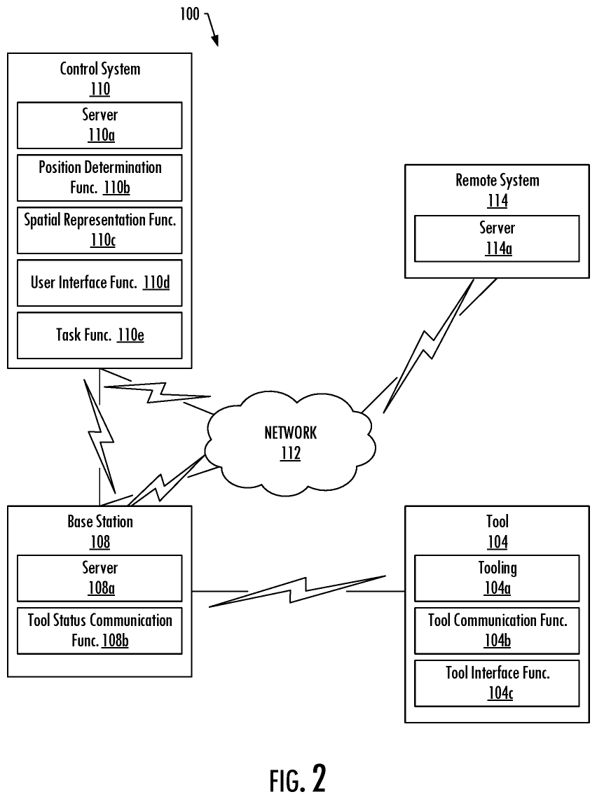

FIG. 2 illustrates a functional block diagram of a portion of the system presented in FIG. 1, according to example implementations of the present disclosure. As shown in FIG. 2, the system 100 include the tool 104, one or more base station(s) 108, a control system 110, and a remote system 114. As discussed herein with respect to FIG. 1, the tool 104 is configured to wirelessly communicate with the base station 108. The base station 108 is configured to communicate with the control system 110 through a direct wired or wireless connection, or via network 112. The base station 108 and the control system 110 may communicate with remote system 114 via network 112.

In some example implementations of the present disclosure, the tool 104 is a handheld tool with a communication device incorporated into or otherwise affixed to the tool. As shown in FIG. 2, some example configurations of such a tool 104 include tooling 104a, a tool communication function 104b, and a tool interface function 104c. Tooling 104a includes the mechanical, electrical, electromechanical, and other components that allow tool 104 to engage or otherwise interact with one or more fasteners, fastener collars, or other components of a product. For example, in some example implementations, the tool 104 is a torque wrench with a communication device affixed to it. In some such example implementations, tooling 104a includes the portions of the tool used to engage with a nut or other fastener (such as a bnut or hex screw, for example), apply or direct force to the fastener, measure the torque applied to the fastener, and otherwise perform the functions of a torque wrench. It will be appreciated that while some of the examples discussed herein are directed to tasks or other operations involving the application of a specific amount of torque to a nut with a torque wrench, example implementations of the present disclosure may be used with any of a number of tools, including but not limited to wrenches, screw drivers, nut drivers, pliers, clamps, crimping tools, hammers, mallets, shaping tools, probes, electrical sensors, chemical sensors, or other tools that may be appropriate for a given task or operation, for example. It will be appreciated that the tooling 104a associated with a specific implementation of a tool 104 will depend on the type of tool used in a given implementation.

As discussed herein, example implementations of the present disclosure involve tools, such as tool 104, that have a communication device affixed thereto. As shown in FIG. 2, tool 104 includes tool communication function 104b. In example implementations of tool 104, the tool communication function 104b includes all of the hardware, firmware, software, and other circuitry or other data that is used by tool 104 to communicate with a base station, such as base station 108, to determine the position of the tool 104. In some example implementations, the tool communication function 104b includes components from a virtual reality system, such as HTC Vive virtual reality system components, mixed reality system components, and/or augmented reality system components. However, it will be appreciated that any system capable of providing location information identifying a position a device (and thus the tool 104 when such as device is incorporated into or otherwise affixed to the tool 104), at a sub-centimeter or sub-millimeter level of precision may be used in example implementations of tool communication function 104b. In some example implementations, the tool communication function 104b, in conjunction with the base station 108 and/or other components of system 100, is able to determine the position of the tool within a given three-dimensional space 102 in the form of coordinates in the three-dimensional space 102 or a vector with respect to one or more reference points, such as fixed location of a base station, for example. In some such example implementations, the tool communication function 104b may also be able to determine a roll, pitch, or yaw of the tool with respect to one or more axes associated with tool 104. As such, some example implementations of the tool 104 and tool communication function 104b allow for the determination and communication of precise information regarding the position of the tool 104 in space and the orientation of the tool at its position in space. In some example implementations, the movement of the tool 104 can be used to refine or confirm a location of a fastener or other component. For example, in situations where the tool rotates around a fastener, the circular, spherical, or other pattern traced by the movement of the tool may be used to determine the center of the pattern as an estimate of the position or the relevant fastener or component. Since the position of the communication device on the tool with respect to the portion of the tool that is used to engage a fastener or otherwise perform an operation will generally be known, example implementations of the tool 104 and the tool communication function 104b can be used to precisely identify the point of engagement of the tool with the fastener or other relevant component, and the orientation of the tool when it is engaged with the fastener or other relevant component. In such situations where the position and orientation of the tool is received in real-time or near real-time, or where an accurate timestamp is applied to the position and orientation information, the linear velocity, rotational velocity, and relevant accelerations of the tool can be derived.

In addition to being able to communicate with a base station, such as base station 108, to determine a position of the tool 104, the tool communication function 104b may also be used to pass additional information about the tool 104 (such as information gained from the tooling 104a or input supplied by a user via tool interface function 104c, for example) to the base station for further transmission or processing by the base station 108, control system 110, or other aspects of the system 100. As noted herein, some example implementations of the system 100 arise in contexts where the tool 104 is a torque wrench. In some such example implementations, the torque applied to a fastener and/or the torque status of a fastener that has been engaged by the tool 104 is captured with the tooling 104a and communicated, through the operation of tool communication function 104b, to the control system 110 via a base station 108 for storage, presentation via a graphical user interface (GUI), or otherwise processed. It will be appreciated that the types of information conveyed via the tool communication function 104b may be based at least in part on the tooling 104a, other aspects of the tool 104, and the specific tasks or operations performed with the tool 104. Moreover, in addition being configured to transmit information to a base station 108, it will be appreciated that the tool communication function 104b may also be used to receive data from a base station 108, for example.

As shown in FIG. 2, some example implementations of tool 104 include a tool interface function 104c, which is used to allow a user to supply input (such as through the pressing or other engagement of one or more buttons or other input devices, for example) and to allow information to be conveyed to a user in a human-discernible form. The tool interface function 104c includes the hardware, firmware, software, other information, and other circuitry or components needed to capture user input and supply feedback to the user. For example, audio feedback (such as in the form of beeps, audible pulses, or other sounds, for example), visual feedback (such as through the activation of one or more LED indicators or displays, for example), or haptic feedback (such as in the form of a vibration of the tool 104, for example) may be provided through the operation of the tool interface function 104c. It will be appreciated that, in some example implementations, user input (such as a button press to indicate that the tool 104 is engaged with a fastener, for example, or is otherwise engaged in a particular task, for example, is passed between the tool interface function 104c to the tool communication function 104b for transmission to a base station (such as base station 108) and/or control system 110 or another component of system 100.

In some example implementations, base station 108, as shown in FIG. 2 is configured to communicate wirelessly with a tool 104, and may also communicate with a control system 110, and a remote system 114, either directly or via a network 114. Base station 108 work with the tool 104 (such as through interaction with tool communication function 104b or components that enable communication to establish the position of the tool, for example) to determine the position of the tool 104 within a three-dimensional space and generate data identifying that position that can be passed to other system components. In some example implementations, a base station 108 may include a server 108a and a tool status communication function 108b. The server 108a may facilitate the development, storage, transmission, acquisition, and other interactions with information within the system 100. For example, the server 108a may be used to store and send information to the control system 110 or the remote system 114 regarding the position of the tool 104, and may also be used to receive information from the control system 110 or the remote system 114, such as the relative position of the tool with respect to one or more previously mapped components, information regarding tasks to be performed in conjunction with the tool 104, information that may be used to provide feedback at the tool 104, or the like, for example.

In some example implementations, the tool status communication function 108b acts as a complementary function to the tool communication function 104b, at least in the sense that it includes any hardware, firmware, software, other circuitry or other information necessary to facilitate communication between the base station 108 and the tool 104 to determine the position of the tool 104 within a three-dimensional space and convey information to the tool 104, such as information used to generate audio, visual, or haptic feedback at the tool 104.

As shown in FIG. 2, the system 100 also includes control system 110, which is configured to communicate with the base station 108 through either a wired or wireless direct connection or via a network 112. Control system 110 may also communicate with a remote system 114 via network 112. In some example implementations of the present disclosures, control system 110 is a computer configured to receive (such as from base station 108, for example) data identifying a position of the tool 104, use that position and a user input to identify the location of a corresponding fastener, fastener collar, or other component of an object, generate a digital representation of a relevant region of three-dimensional space including an identification of the location of the corresponding fastener, fastener collar, or other component, and generate a graphical user interface (GUI) with a visual representation of the map of the three-dimensional space and a visual representation of the location of the corresponding fastener, fastener collar, or other component. In some example implementations, control system 110 may be a computer configured to also access a map or other data including an identification of a fastener, fastener collar, or other component, determine a relative position of the tool with respect to the fastener, fastener collar, or other component, and provide an indication to a user of the relative positioning of the tool and the corresponding fastener, fastener collar, or other component. As described and otherwise disclosed herein, the control system 110, in conjunction with the base station 108, tool 104, and remote system 114, can be used in example implementations to perform a broad array of tasks.

As shown in FIG. 2, some example implementations of control system 110 include a server 110a, a position determination function 110b, a spatial representation function 110c, a user interface function 110d, and a task function 110e. The server 110a may be used, in some example implementations, to facilitate the development, storage, transmission, acquisition, and other interactions with information within the system 100. For example, the server 110a may be used in connection with generating, storing, accessing, and sharing one or more digital representations of various three-dimensional spaces and the fasteners, fastener collars, or other components therein. In some example implementations, the server 110a may also be used to store information acquired from the tool, such as information acquired from the tooling 104a and tool communication function 104b. For example, server 110a may store a torque status of a bnut or other fastener at a particular time, time or date information regarding the engagement of a tool with one or more components, or other information regarding forces applied by the tool 104 or other information acquired by the tool 104. In some example implementations, the server 110a may be used to access or store protocols to be used in connection with one or more tasks that a user equipped with tool 104 could follow in the course of manufacturing, maintaining, or repairing a portion of an aircraft or other product. It will be appreciated that numerous types of information pertaining to the tool, the movement of the tool, the position of the tool, information pertaining to a fastener, fastener collar, and other component or feature may be captured and stored. For example, voice annotations, one or more images (such as images of specific locations or features, for example), linear and/or angular velocities of the tool, and other notations may be stored in connection with a relevant record or protocol.

The control system 110 may also include a position determination function 110b, which includes the hardware, firmware, software, other circuitry, and other data necessary to use tool position information received from a base station 108, information about the position of one or more fasteners, fastener collars, or other components that may be stored, received, or otherwise accessed by the control system 110, and information about one or more relevant three-dimensional spaces in connection with example implementations of the present disclosure. In some example implementations, such as those involved in applying sealant along a lap seam, the control system 110 may use material extrusion sensor information with the position and orientation of the sealant applicator tip relative to designed or taught part geometry. The control system 110 may also include a spatial representation function 110c, which includes hardware, firmware, software, other circuitry, and other data needed to generate, modify, and interact with digital representations, maps, and other data associated with representing a three-dimensional space and the positions of one or more object within the three-dimensional space.

As shown in FIG. 2, the control system 110 may also include a user interface function 110d, which includes hardware, firmware, software, other circuitry, and other data needed to provide a user interface. In some example implementations, the user interface may include a monitor, headset, or other visual display capable of presenting a visual representation of a three dimensional space, the positions of one or more objects within the three dimensional space, and other information to a viewer. In some example implementations, the user interface function 110d may also be used to accept information from a user in the form of button presses, keyboard entry, touchscreen interaction, or other approaches to receiving information from a user. The control system 110 may also include a task function 110e, which includes the hardware, firmware, software, other circuitry and other information needed to access, generate, modify, provide, and otherwise interact with information associated with one or more tasks that may be performed in connection with a given tool 104 and/or a given three-dimensional space. For example, the task function 110e may provide information to a user regarding the procedures to be performed with a given tool 104 as part of a particular manufacturing, maintenance, or repair operation, and track information about the use of the tool 104 via the base station 108, and determine the extent to which a given task was completed.

As shown in FIG. 2 example implementations of the system 100 may also include a remote system 114, which is configured to communicate with one or more other systems or other components in system 100 via a network 112. In some example implementations, the remote system allows a user to view or otherwise monitor aspects of system 100. For example, a remote system 114 may allow a user to view a copy or other version of the GUI generated by control system 110, and thereby see representations of the movement of a tool 104, the locations or statuses of one or more components within a three-dimensional space, or information regarding the progress of a user through a given task. In some example implementations, the remote system may include a monitor or headset that allows a user of the remote system 114 to have a viewing experience that closely matches that available to a user of the control system 110 or a user of the tool 104, for example, and may allow the user of a remote system 114 to exchange information with one or more other aspects of system 100. In situations where a virtual reality environment is used in connection with generating and/or presenting a representation of a three-dimensional environment to a user, the remote system 114 may allow a user to interact with the virtual reality environment. In some example implementations, the remote system 114 allows for a viewer to receive and transmit images and other information in real-time or near real-time, which can allow a remote viewer to contemporaneously verify actions taken by a user of a tool in a different location. In some example implementations, the remote system 114 may access previously captured images or information. As shown in FIG. 2, some example implementations of remote system 114 include a server 114a, which may facilitate the development, storage, transmission, acquisition, and other interactions with information within the system 100.

Regardless of the configuration system 100 and the configuration or combination of one or more systems, functions, or other aspects included therein, it will be appreciated that example implementations of the present disclosure allow for the determination of the position or movement of a tool within a three dimensional space, and the use of information about the three-dimensional space and the fasteners, fastener collars or other components contained therein to overcome technical challenges encountered in the manufacture, maintenance, and repair of complex products. Some examples are described herein to provide details regarding some of the approaches that can be used in connection with example implementations of the present disclosure. These examples should be considered to be a non-exclusive list, and are not intended to limit the scope or nature of other potential implementations of the present disclosure.

In some example implementations, the tool 104 may be a torque wrench that is configured to engage with one or more fasteners or fastener collars, communicate with a base station 108 and otherwise be used within a three-dimensional space 102. While in some such example implementations, a communication device (such as a device capable of performing the operations described herein with respect to tool communication function 104b and tool interface function 104c, for example) may be affixed to the tool 104 through integration with the tool 104, some example implementations involve the affixing of a separate device to the tool 104, which can allow for the augmentation of existing, previously purchased or acquired tools to achieve at least some of the aspects and advantages of the present disclosure. In some such example implementations, such an affixed device may operate independently of any software already incorporated into the tool 104 (such as software associated with a strain gauge or other force measurement component, for example).

In some example implementations where the position and orientation of a tool 104 is available to a computer (such as control system 110, for example), the position and orientation information may be used to check and otherwise process torque or other force information received from the tool 104. It will be appreciated that in some example implementations involving a torque wrench or other tool configured with force sensors, the orientation of the tool can dictate the direction of the forces detected by the force sensors. As such, when a torque wrench is flipped over, the measured forces may be stored as being applied in the opposite direction. Since the computer has access to information about the actual movement of the tool (such as the position of the tool, the orientation of the tool, and changes to the position and/or orientation of the tool over time, for example), disparities between the known movement of the tool and captured force information can be resolved. For example, if tool 104 is a torque wrench that has been inadvertently flipped over, the force sensors in tooling 104a may generate information indicating that force was applied in a loosening direction, rather than accurately capturing the tightening operation performed by the tool. The tool 104 passes the position information and force information via the operation of tool communication function 104b to the base station 108, which in turn supplies the information to the control system 110. Upon receiving the information, the control system 110 (such as through the operation of position determining function 110b and/or task function 110e, for example) may detect a conflict between the direction of movement of the tool 104 and the direction of the force applied reflected in the force data. Based on the known movement of the tool, the discrepancy can be resolved by the control system 110 by correcting the direction of the received force data, and storing force data that accurately represents the actual operation of the tool 104.

By capturing the position and orientation of the tool, some example implementations allow for the precise detection of the point of engagement between the tool and the fastener or other relevant component. As noted herein, some example implementations of the tool 104 and tool communication function 104b allow of the determination of the position of the tool within the sub-centimeter or sub-millimeter range. Since the position of the communication device on the tool with respect to the engagement portion of the tool can be precisely measured for a given tool, the position and orientation information can be used to precisely determine how the tool is positioned, oriented, and moved when engaged with a fastener or other relevant component. It will be appreciated that, in many situations, the torque applied to a fastener is a function of the force applied to the wrench handle and the angle of the wrench to the fastener centerline axis. When the wrench is perpendicular to the fastener centerline axis, all of the force applied to the wrench handle is converted into a rotational moment at the fastener in order to tighten or loosen the fastener. It will be appreciated that, when an open ended wrench is employed, the wrench may be positioned at one or more angles other than perpendicular to the fastener axis. In such situations, some of the force on the wrench handle is reacted by a bending moment in the fastener and does not contribute to the rotational moment tightening the fastener. The force that does not contribute to the rotational moment tightening of the fastener may be referred to as off-axis torque loss, and the amount of force on the handle contributing to tightening the fastener can be expressed as being proportional to the cosine of the angle between the wrench handle and the perpendicular to the fasteners axis. In example implementations where the roll, pitch, and yaw orientation of the tool is captured in conjunction with its position in a three-dimensional space, the computer (such as control system 110, for example) can determine if a wrench is applied to a fastener at an angle that is not perpendicular to the relevant fastener axis, and adjust the torque value stored in memory and associated with the given fastener to account for off-axis torque loss.

Some example implementations of the present disclosure include the ability for audio, visual, or haptic feedback to be provided to a user of the tool. In some such example implementations, audible tones are used to guide the user to place the tool 104 in a particular location within the three-dimensional space 102, such as a location associated with a fastener 106, for example. A characteristic of the audible tone (such as the pitch, tone length, of tempo at which the tone is repeated, for example) may be altered based on the proximity of the tool 104 to the fastener 106. In situations where one or more fasteners 106 are blocked from view or otherwise difficult to see, such audible feedback can be used to guide the user to the proper location. It will be appreciated that such feedback may, in some example implementations, be selectively activated by a user, such as by pressing a button on the tool 104 or through an operation of tool interface function 104c, for example. In some example implementations, such as where there may be multiple relevant fasteners 106, each different sounds may be assigned to each fastener 106 to allow a user to differentiate the fasteners and efficiently move from fastener to fastener.

In some example implementations, such as those that arise in contexts involving the manufacture, maintenance, or repair of complex, component-dense portions of a product, for example, it may be difficult for a user to confirm that they have completed all of the operations associated with a given tool for a given task. Some example implements involve a computer (such as control system 110, for example) to access and/or capture information about a given task, its status, and, in some examples, provide feedback or other information to a user regarding that task.

In some such example implementations, haptic feedback provided by the tool 104 is used to indicate a completion status of a task to a user. For example, if a task requires that a certain set of fasteners be engaged and checked for a proper torque application, the computer (such as through the operation of task function 110e, for example) may record the status of each fastener checked by the user. If the user completes the task, appears to move away from the three-dimensional space, or requests information about the status of the task, or the like, for example, the task function 110e can cause the control system 110 to provide information to the tool 104 (via base station 108) that causes the tool interface function 104c to provide haptic feedback to the user indicating that more operations are necessary, or that the task is complete. Some such example implementations may reduce the need for a user to repeatedly consult a visual interface (such as one associated with the control system 110, for example) or repeatedly refer to one or more operations manuals during the course of their work.

In some example implementations, visual, audio, and/or haptic feedback may be used in connection with quality assurance processes and/or other auditing processes. In some such example implementations, the feedback may be used to signal to a user that a particular fastener, component, or other feature should be checked. For example, if the tool 104 is in the form a bore gauge used to check the diameter of one or more of a series of holes, a light, sound, vibration, or other feedback may be used to signal to a user that the hole near the gauge should be checked, and the information captured by the gauge can be stored with the relevant record.

Other example implementations use the ability to of a computer (such as control system 110, for example) to store information associated with one or more fasteners and/or tasks to identify potential fault conditions. For example, in some example implementations, fastener or other component may be flagged as suspect or scheduled for follow-up if a tool is applied engaged or placed near the fastener or other component, but no force is recorded as being applied. In some example implementations, the torque associated with a fastener can be confirmed by recognizing that a tool was engaged with the fastener, and the tool did not move even when a force was applied.

In some other example implementations involving an identification of a fastener as suspect or in need of follow-up, the status of the fastener stored by the system can be taken into account. For example, if a fastener that was identified in the system as being tight moves with the application of a relevant torque, that fastener and/or nearby fasteners can be marked for follow-up work, as the system may be incorrectly identifying the relevant space, or work may have been performed but not recorded. Similarly, if a fastener identified in the system as not being tightened requires an unexpected amount of force to be applied, that fastener may be cross-threaded or require further inspection, which can be stored in the system.

Some example implementations of the present disclosure involve the use of aspects of system 100 to allow for improvements in the training of users and the inspection of one or more task performed by users. In some implementations involving a remote system 114, a viewer at remote system 114 may use a monitor or virtual reality headset, for example, to watch the operations performed by a user of the tool 104. Such remote view or remote inspection may be advantageous in situations where conditions at a given three-dimensional space restrict the ability of multiple people to be in a given space. In some example implementations, the use of a remote system 114 and/or information captured during the performance of one or more tasks may be used to train viewers of a remote system 114 to see how a given operation is properly performed.

It will be appreciated that in some example implementations, tools other than a wrench or other fastening tool may be used. For example, inspections tools may be used to assess one or more inspection points, such as a holes, physical or electrical resistance, step measurements, and gap measurements, for example. Moreover, regardless of the tooling incorporated into the tool, some example implementations use the data captured in the course of a given task as an automated or semi-automated inspection method. Since the computer (such as control system 110 and task function 110e) can, in some example implementations, record the status of a fastener or other component, and the movement of a tool, at a certain time, a record of the operations performed on one or more fasteners or other components can be checked against one or more relevant requirements.

In some example implementations, the system 100 may be used in the development or analysis of various manufacturing, maintenance, or repair protocols. For example, the system 100 (such as through the operation of control system 110 and task function 110e, or through the operation of another computer, for example) the system 100 may track the sequence of operations for a given task, and track how many times adjustments need to made or work needs to be checked or re-performed during the course of a task or series of tasks. This information may be used to identify and develop standardized practices for future use.

As noted herein, some example implementations involve the use of virtual reality system components. In some such example implementations, a camera associated with a virtual reality headset can be used to create a visual record of three dimensional space and the objects therein. In some such example implementations, real-time or near real-time video or other images may be captured to document the status of a fastener or other component and/or the interaction of the tool with that fastener or other component. In some example implementations, the view captured by the camera may be enhanced with information about the location of a fastener or other component, thus enabling a user to see a representation of a given fastener or component in the virtual reality display, even if the fastener would not be directly viewable due to the presence of other objects in a given line of sight.

Some example implementations also involve aspects of self-diagnosis with respect to the determination of the position of a tool. For example, in instances where the computer (such as control system 110, for example) detects intermittence and/or inconsistencies in the position of a tool, or in instances where the base station 108 indicates that communication with a tool 104 is intermittent or weak, the computer may alert the user, and the user may adjust their position or other take steps to ensure proper tracking of the tool position. For example, if the base station or the computer determines that the signal received from the tool is blocked, intermittent, or in any other condition that may compromise the accuracy of the determination of the position of the tool, the computer or the base station may present an alert (such as via a user interface of the computer or as feedback at the tool, for example) that the user may need to take additional steps to restore or improve the communication between the tool and other system components.

In some example implementations, the computer (such as control system 110, in connection with the operation of the server 110a, position determination function 110b, and spatial representation function 110c, for example) may use information about the position of one or more fasteners located by or engaged by the tool 104 to generate a map of the fasteners, access one or more previously stored maps of fastener positions, and fit the generated map to the previously stored map. In some such example implementations, fitting a generated map (or a portion of a generated map) to a previously stored map can reduce the inadvertent creation of multiple inconsistent records, align system axes, and track operations. For example, as locations are identified (such as through the use of a tool, for example) those locations may be used to interrogate a database of previously-stored maps or other records. Upon finding a record that fits the location data, the more recently-identified locations can be used to confirm and/or update the existing record. Some example implementations that use the positions of one or more fasteners or other components to align a given space with an existing map may be able to efficiently establish axes or other frames of reference for a space in a manner that saves time in a production, maintenance, or repair environment.

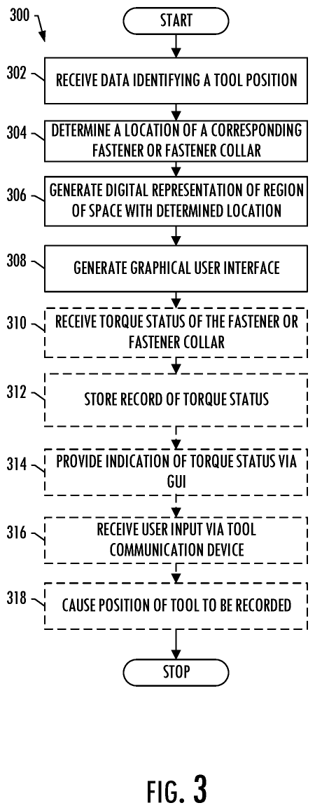

FIG. 3 is a flowchart illustrating various steps in a method 300 for affixing a fastener or fastener collar, according to example implementations of the present disclosure. It will be appreciated that many example implementations of the method 300 arise in a context involving a handheld tool configured to engage a corresponding fastener or fastener collar; a communication device affixed to the handheld tool and configured to wirelessly communicate with a base station; and a computer configured to perform one or more operations. It will be appreciated that the systems described here, including but not limited to those discussed in connection with FIGS. 1 and 2, may be used in connection with implementations of method 300.

As shown at block 302, the method 300 includes receiving data identifying a tool position. Some example implementations of block 302 involve receiving, at a computer, from a base station, data identifying a position, within a region of three-dimensional space, of a handheld tool to which a communication device is affixed. With reference to FIG. 1 and FIG. 2, some example implementations of block 302, the tool 104 with its affixed communication device interacts with a base station 108 to determine the position of the tool 104 within a given three-dimensional space 102, and this determined position is passed from the base station 108 to the computer, in the form of control system 110.

As shown at block 304, the method 300 includes determining a location of a corresponding fastener or fastener collar. Some example implementations of block 304 include determining, based on the position of the handheld tool and a user input, a location of a corresponding fastener or fastener collar. In some such example implementations, user input is used to signal that the tool is engaged or otherwise placed in a location associated with a corresponding fastener or fastener collar, as opposed to being simply put at rest or held in a given position. In some example implementations, the user input may be supplied at the tool (such as through a user's interaction with tool 104 and its tool interface function 104c, for example) or at the computer (such as through a user's interaction with control system 110 and its user interface function 110d, for example).

As shown at block 306, the method 300 includes generating a digital representation of a region of space with the determined location. Some example implementations of block 306 include generating a digital representation of the region of three-dimensional space including an identification of the location of the corresponding fastener or fastener collar. As discussed and otherwise disclosed herein, such as in connection with FIG. 1 and FIG. 2, for example, some example implementations of the present disclosure allow for the generation of a digital representation of a given region of three-dimensional space and one or more fasteners or fastener collars therein, such that the position, status, and other information associated with the fastener or fastener collar can be accessed, transmitted, shared, or otherwise presented to a user.

As shown at block 308, the method 300 also includes generating a graphical user interface. Some example implementations of block 308 include generating a graphical user interface (GUI) including a visual representation of the map of the three-dimensional space and a visual representation of the location of the corresponding fastener or fastener collar. In some such example implementations, the GUI may be presented to the user via a monitor associated with a computer, such as a monitor associated with the control system 110 and its user interface function 110d. In some example implementations, the GUI may be presented to a user in a virtual reality headset and may be augmented with additional information, such as one or more video images of the three-dimensional space. It will also be appreciated that any of a number of approaches may be used in presenting information to a user via the GUI, such as color-coding one or more image elements, the use of text or non-textual information, or the like. In some example implementations of block 308, the visual representation of the region of three-dimensional space comprises a rendering of the region of three-dimensional space and a rendering of the corresponding fastener or fastener collar applied to the rendering of the region of three-dimensional space in a position on the GUI corresponding to the location of the corresponding fastener or fastener collar within the region of three-dimensional space.

As shown in FIG. 3, the method 300 may incorporate additional steps. As shown at block 310, the method 300 may include receiving the torque status of the fastener or fastener collar. In some example implementations, the handheld tool is a torque wrench and the communication device is configured to transmit a torque status of the corresponding fastener or fastener collar to the base station. In some such example implementations, the tool (such as tool 104) is able to capture and convey torque information via the base station 108 to the computer (such as control system 110, for example) to provide torque status information regarding a fastener or other component.

As shown at block 312, the method 300 may further include storing a record of the torque status. Some example implementations of block 312 include storing a record of the torque status of the corresponding fastener or fastener collar. In some example implementations of block 312, the torque status may be stored by the computer (such as control system 110, for example) and/or stored in one or more servers in communication with the computer via a network.

As shown at block 314, the method 300 may also include providing an indication of the torque status via the GUI. It will be appreciated that any of a number of approached to indicating a torque status on GUI may be used in connection with example implementations of block 314. For example, an indication of a fastener on the GUI may be color coded based on the torque status, text identifying the torque status may be presented on the GUI, and/or other approaches to conveying information to a use via a GUI may be used.

As shown at block 316, the method 300 may also include receiving user input via the tool's affixed communication device. In some example implementations of block 316, the communication device is further configured to receive the user input via a user interface of the communication device. As discussed herein with respect to block 302, tool 104, and system 100, some example implementations of tool 104 feature a user interface, which a user may interact with (such as by pushing a button, for example) to indicate that the is in a position that should be recorded.

As shown at block 318, the method 300 may also include causing the position to be recorded. Some example implementations of block 318 include the communication device being configured to transmit a signal to the base station to cause the computing device to record the position of the handheld tool within the region of three-dimensional space on the map.

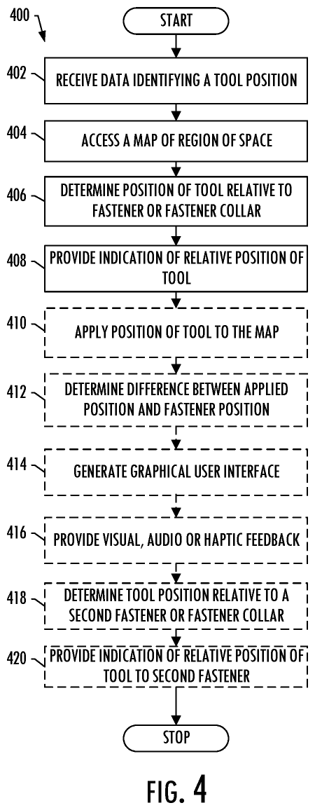

FIG. 4 is a flowchart illustrating various steps in a method 400 for affixing a fastener or fastener collar, according to example implementations of the present disclosure. It will be appreciated that many example implementations of the method 400 arise in a context involving a handheld tool configured to engage a corresponding fastener or fastener collar; a communication device affixed to the handheld tool and configured to wirelessly communicate with a base station; and a computer configured to perform one or more operations. It will be appreciated that the systems described here, including but not limited to those discussed in connection with FIGS. 1 and 2, may be used in connection with implementations of method 400.

As shown at block 402, the method 400 includes receiving data identifying a tool position. Some example implementations of block 402 include receiving, at a computer, from a base station, data identifying a position, within a region of three-dimensional space, of a handheld tool to which a communication device is affixed. It will be appreciated that the tool 104, base station 108, and control system 110 and/or similar devices may be used in connection with example implementations of block 402.

As shown at block 404, the method 400 also includes accessing a map of a region of space. Some example implementations of block 404 include accessing a map of the region of three dimensional space, including an identification of the location of the corresponding fastener or fastener collar. As discussed herein with respect to system 100, some example implementations contemplate the use of a tool, such as tool 104, to perform one or more tasks in a space that has been previously mapped, and tracking the performance of those tasks based at least in part on determining the position and movement of the tool.

As shown at block 406, the method 400 also includes determining a position of the tool relative to a fastener or fastener collar. Some example implementations of block 406 include determining, based on the position of the handheld tool and the identification of the location of the corresponding fastener or fastener collar, a relative position of the handheld tool with respect to the corresponding fastener or fastener collar. By determining a position of the tool relative to the corresponding fastener or fastener collar, example implementations of block 406 provide a context in which the tool can be guided to a relevant location and tasks performed by the tool in connection with the corresponding fastener or fastener collar can be tracked and recorded.

As shown at block 408, the method 400 also included providing an indication of the relative portion of the tool. Some example implementations of block 408 include provide an indication of the relative position of the handheld tool with respect to the corresponding fastener or fastener collar. As noted with respect to block 406, providing an indication of the location of a tool with respect to a given fastener or fastener collar can allow for a user of the tool to more readily move the tool and perform any of a number of tasks.

As shown in FIG. 4, the method 400 may include any of a number of additional steps. For example, as shown at block 410, the method 400 may include applying the position of the tool to the map. Some example implementations of block 410 include applying the position of the handheld tool within the region of three-dimensional space to the map. It will be appreciated that implementations of block 410 may represent one approach to providing visual feedback to a user of the relative positions of the tool and the corresponding fastener or fastener collar, and otherwise storing the location of the tool.

As shown at block 412, the method 400 may include determining a difference between the applied position of the handheld tool and the identification of the location of the corresponding fastener or fastener collar. As discussed and otherwise disclosed herein with respect to system 1, the tool may be used to perform a range of tasks depending on the configuration of the tool. As such determining a difference between the position of a tool applied to a map and that of a corresponding fastener, for example, can facilitate the determination of whether, when, and/or how a task was performed by the user and the tool.

As shown at block 414, the method 400 may include generating a graphical user interface (GUI). Some example implementations of block 414 include generating a graphical user interface (GUI) including a visual representation of the map of the three-dimensional space, a visual representation of the location of the corresponding fastener or fastener collar, and a visual indication of the position of the handheld tool with respect to the corresponding fastener or fastener collar. In some such example implementations, the GUI can be used by a user to identify how the tool may be moved to place it in a position to engage with a fastener or other relevant component.

As shown at block 416, the method 400 may include providing visual, audio, or haptic feedback. Some example implementations of block 416 include the computer being configured to transmit to the communication device, via the base station, the indication of the relative position of the handheld tool with respect to the corresponding fastener or fastener collar and the communication device being is further configured to provide visual, audio, or haptic feedback to the user based on the indication of the relative position of the handheld tool with respect to the corresponding fastener or fastener collar. As discussed herein with respect to example implementations of system 100, the use of audio, visual, or haptic feedback at the tool may assist a user in locating a relevant fastener or other component or otherwise performing one or more task. In some example situations, the feedback may be used to guide the user towards a fastener or other component. In some such example implementations, a characteristic of the visual, audio or haptic feedback is based at least in part of the relative position of the handheld tool with respect to the corresponding fastener of fastener collar.

As shown at block 418, the method 400 may include determining the tool position relative to a second fastener or fastener collar. Some example implementations of block 418 wise in contexts where the locations of multiple fasteners or fastener collars are reflected on the map. As such, some example implementations of block 418 include determining, based on the position of the handheld tool and the identification of the location of the second corresponding fastener or fastener collar, a relative position of the handheld tool with respect to the second corresponding fastener or fastener collar.

As shown at block 420, the method 400 may also include providing an indication of the relative position of the tool to the second fastener. Some example implementations of block 420 include providing an indication of the relative position of the handheld tool with respect to the second corresponding fastener or fastener collar. It will be appreciated that any approach to providing an indication of a relative position of a tool with respect to a fastener or fastener collar may be used in connection with example implementations of block 420, including but not limited to any such approaches that may be used in connection with block 408, for example.

According to example implementations of the present disclosure, the system 100 and its subsystems including the tool 104, base station 108, control system 110 and remote system 114 may be implemented by various means. Means for implementing the system and its subsystems may include hardware, alone or under direction of one or more computer programs from a computer-readable storage medium. In some examples, one or more apparatuses may be configured to function as or otherwise implement the system and its subsystems shown and described herein. In examples involving more than one apparatus, the respective apparatuses may be connected to or otherwise in communication with one another in a number of different manners, such as directly or indirectly via a wired or wireless network or the like.

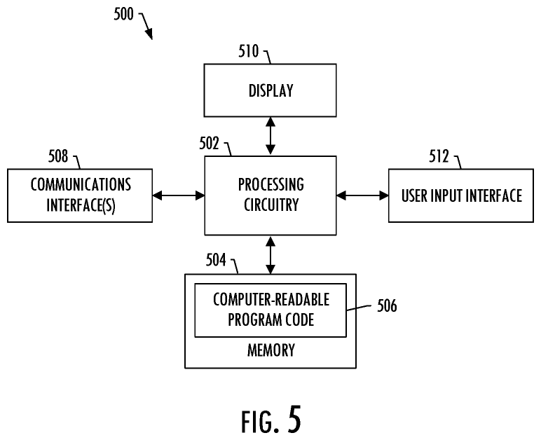

FIG. 5 illustrates an apparatus 500 according to some example implementations of the present disclosure. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, processing circuitry 502 (e.g., processor unit) connected to a memory 504 (e.g., storage device).

The processing circuitry 502 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry- or otherwise stored in the memory 504 (of the same or another apparatus).

The processing circuitry 502 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 504 is generally any piece of computer hardware that is capable of storing information such as, for example, data, computer programs (e.g., computer-readable program code 506) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory, signals capable of carrying information from one location to another. Computer-readable medium as described herein may generally refer to a computer-readable storage medium or computer-readable transmission medium.

In addition to the memory 504, the processing circuitry 502, may also be connected to one or more interfaces for displaying, transmitting and/or receiving information. The interfaces may include a communications interface 508 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless MC (WNIC) or the like.

The user interfaces may include a display 510 and/or one or more user input interfaces 512 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 500 may include a processing circuitry 502 and a computer-readable storage medium or memory 504 coupled to the processing circuitry, where the processing circuitry is configured to execute computer-readable program code 506 stored in the memory. It will also be understood that one or more functions, and combinations of functions, may be implemented by special purpose hardware-based computer systems and/or processing circuitry which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for affixing a fastener or fastener collar comprising:
a handheld tool configured to engage a corresponding fastener or fastener collar;
a communication device affixed to the handheld tool and configured to wirelessly communicate with a base station; and
a computer configured to:
receive, from the base station, data identifying a position, orientation and movement of the handheld tool within a region of three-dimensional space;
determine a location of the corresponding fastener or fastener collar, based on the position, orientation and movement of the handheld tool and a user input to a user input interface of the communication device or the computer, and without a previously-stored or mapped location of the corresponding fastener or fastener collar;
generate a graphical user interface (GUI) including a digital representation of the region of three-dimensional space with an identification of the location of the corresponding fastener or fastener collar.

2. The system of claim 1, wherein the handheld tool is a torque wrench, and the communication device is configured to transmit a torque status of the corresponding fastener or fastener collar to the base station; and
wherein the computer is further configured to:
receive the torque status of the corresponding fastener or fastener collar;
store a record of the torque status of the corresponding fastener or fastener collar; and
provide an indication the torque status via the GUI.

3. The system of claim 1, wherein the communication device is further configured to receive the user input via the user input interface of the communication device and transmit a signal to the base station to cause the computer to record the position of the handheld tool within the region of three-dimensional space on the digital representation.

4. The system of claim 1, wherein the GUI includes a rendering of the region of three-dimensional space and a rendering of the corresponding fastener or fastener collar applied to the rendering of the region of three-dimensional space in a position on the GUI corresponding to the location of the corresponding fastener or fastener collar within the region of three-dimensional space.

5. A system for affixing a fastener or fastener collar comprising:
a handheld tool configured to engage a corresponding fastener or fastener collar;
a communication device affixed to the handheld tool and configured to wirelessly communicate with a base station; and
a computer configured to:
receive, from the base station, data identifying a position, orientation and movement of the handheld tool within a region of three-dimensional space;
access a map of the region of three dimensional space, including an identification of a location of the corresponding fastener or fastener collar;
determine, based on the position of the handheld tool and the identification of the location of the corresponding fastener or fastener collar, a relative position of the handheld tool with respect to the corresponding fastener or fastener collar;
determine, based on one or more force measurements, and the orientation and movement of the handheld tool, one or more forces applied by the handheld tool on the corresponding fastener or fastener collar, the one or more forces including respective directions that indicate tightening and loosening operations performed by the handheld tool;
determine a status of the corresponding fastener or fastener collar based on the one or more forces including the respective directions; and
provide an indication of the relative position of the handheld tool with respect to the corresponding fastener or fastener collar, and the status of the corresponding fastener or fastener collar.

6. The system of claim 5, wherein the computer being configured to determine the relative position of the handheld tool with respect to the corresponding fastener or fastener collar comprises the computer being configured to:
apply the position of the handheld tool within the region of three-dimensional space to the map; and
determine a difference between the applied position of the handheld tool and the identification of the location of the corresponding fastener or fastener collar.

7. The system of claim 5, wherein the computer being configured to provide the indication of the relative position of the handheld tool with respect to the corresponding fastener or fastener collar, comprises the computer being configured to:
generate a graphical user interface (GUI) including a digital representation of the map of the three-dimensional space, with the location of the corresponding fastener or fastener collar, and the position of the handheld tool with respect to the corresponding fastener or fastener collar.

8. The system of claim 5, wherein the computer being configured to provide the indication of the relative position of the handheld tool with respect to the corresponding fastener or fastener collar, comprises the computer being configured to transmit to the communication device, via the base station, the indication of the relative position of the handheld tool with respect to the corresponding fastener or fastener collar; and
wherein the communication device is further configured to provide visual, audio, or haptic feedback to a user based on the indication of the relative position of the handheld tool with respect to the corresponding fastener or fastener collar.

9. The system of claim 8, wherein a characteristic of the visual, audio or haptic feedback is based at least in part of the relative position of the handheld tool with respect to the corresponding fastener or fastener collar.

10. The system of claim 5, wherein the map further includes an identification of a location of a second corresponding fastener or fastener collar.

11. The system of claim 10, wherein the computer is further configured to determine, based on the position of the handheld tool and the identification of the location of the second corresponding fastener or fastener collar, a relative position of the handheld tool with respect to the second corresponding fastener or fastener collar; and
provide an indication of the relative position of the handheld tool with respect to the second corresponding fastener or fastener collar.

12. A method for affixing a fastener or fastener collar, the method comprising:
receiving, at a computer, from a base station, data identifying a position, orientation and movement, within a region of three-dimensional space, of a handheld tool to which a communication device is affixed;
determining a location of the corresponding fastener or fastener collar, based on the position of the handheld tool and a user input to a user input interface of the communication device or the computer, and without a previously-stored or mapped location of a corresponding fastener or fastener collar; and
generating a graphical user interface (GUI) including a digital representation of the region of three-dimensional space with an identification of the location of the corresponding fastener or fastener collar.

13. The method of claim 12, wherein the handheld tool is a torque wrench and the communication device is configured to transmit a torque status of the corresponding fastener or fastener collar to the base station, the method further comprising:
receiving the torque status of the corresponding fastener or fastener collar;
storing a record of the torque status of the corresponding fastener or fastener collar; and
providing an indication of the torque status via the GUI.

14. The method of claim 12, wherein the communication device is further configured to receive the user input via the user input interface of the communication device and transmit a signal to the base station to cause the computer to record the position of the handheld tool within the region of three-dimensional space on the digital representation.

15. The method of claim 12, wherein GUI includes a rendering of the region of three-dimensional space and a rendering of the corresponding fastener or fastener collar applied to the rendering of the region of three-dimensional space in a position on the GUI corresponding to the location of the corresponding fastener or fastener collar within the region of three-dimensional space.

16. A method for affixing a fastener or fastener collar, the method comprising:
receiving, at a computer, from a base station, data identifying a position, orientation and movement, within a region of three-dimensional space, of a handheld tool to which a communication device is affixed;
accessing a map of the region of three dimensional space, including an identification of a location of a corresponding fastener or fastener collar;
determining, based on the position of the handheld tool and the identification of the location of the corresponding fastener or fastener collar, a relative position of the handheld tool with respect to the corresponding fastener or fastener collar;
determining, based on one or more force measurements, and the orientation and movement of the handheld tool, one or more forces applied by the handheld tool on the corresponding fastener or fastener collar, the one or more forces including respective directions that indicate tightening and loosening operations performed by the handheld tool;
determining a status of the corresponding fastener or fastener collar based on the one or more forces including the respective directions; and
providing an indication of the relative position of the handheld tool with respect to the corresponding fastener or fastener collar, and the status of the corresponding fastener or fastener collar.

17. The method of claim 16, further comprising:
applying the position of the handheld tool within the region of three-dimensional space to the map; and
determining a difference between an applied position of the handheld tool and the identification of the location of the corresponding fastener or fastener collar.

18. The method of claim 16, wherein providing the indication of the relative position of the handheld tool with respect to the corresponding fastener or fastener collar further comprises:
generating a graphical user interface (GUI) including a digital representation of the map of the three-dimensional space, with the location of the corresponding fastener or fastener collar, and the position of the handheld tool with respect to the corresponding fastener or fastener collar.

19. The method of claim 16, wherein providing the indication of the relative position of the handheld tool with respect to the corresponding fastener or fastener collar, comprises the computer being configured to transmit to the communication device, via the base station, the indication of the relative position of the handheld tool with respect to the corresponding fastener or fastener collar; and
wherein the communication device is further configured to provide visual, audio, or haptic feedback to a user based on the indication of the relative position of the handheld tool with respect to the corresponding fastener or fastener collar.

20. The method of claim 19, wherein a characteristic of the visual, audio or haptic feedback is based at least in part of the relative position of the handheld tool with respect to the corresponding fastener of fastener collar.

21. The method of claim 16, wherein the map further includes an identification of a location of a second corresponding fastener or fastener collar.

22. The method of claim 21, further comprising:
determining, based on the position of the handheld tool and the identification of the location of the second corresponding fastener or fastener collar, a relative position of the handheld tool with respect to the second corresponding fastener or fastener collar; and
providing an indication of the relative position of the handheld tool with respect to the second corresponding fastener or fastener collar.
